(19) United States
(12) Patent Application Publication
(10) Pub. No.: US 2007/0033150 A1
(43) Pub. Date: Feb. 8, 2007

(54) Biometric web payment system

(75) Inventor: Kingsley Chukwudum Nwosu, Union, NJ (US)

Correspondence Address: Ashok Tankha, Esq.;LIPTON, WEINBERGER & HUSICK, 36 Greenleigh Drive, Sewell, NJ, 08080, US

(73) Assignee: Enenia Biometrics, Inc., Union, NJ (US)

(21) Appl. No.: 11/199,428

(22) Filed: Aug. 8, 2005

(51) Int. Cl. G06F 17/60

(52) U.S. Cl. 705/76

(57) ABSTRACT

This invention provides a reliable and secure method and framework for verifying and authenticating electronic web-based payment customers. This invention describes the enrollment and authentication processes. This invention uses a biometric identification card, a hand-held owner-controlled integrated radio frequency identification (RFID) mobile device hereinafter referred to as the smart device, scanner reader writer device, personal computer, merchant host server, remote backend host server, and gateway host server. This invention describes a method for a customer to enroll in the system whereby the customer's personal, account and biometric information are stored in a BID card or smart device. It also describes a method for a customer to pay for web transactions on a merchants website using one of the accounts stored in the customer's biometric identification card or smart device.

### BACKGROUND OF THE INVENTION

This invention relates to a method that enables internet merchants and service providers to biometrically authenticate web customers, and securely and reliably process the customer's transaction payment utilizing the customer's account.

Electronic commerce has become the backbone of commercial payment processing in industrialized countries and most of the developing economies across the world. The advent of the internet and web browsing has significantly increased the number of web-based transactions. Most of the web based transactions use electronic payment processes that utilize the credit or debit card accounts or bank accounts of customers. When customers make payments over the internet with their credit or debit card accounts, the method of verification is usually in the form of a billing address, security code, social security number, issuing bank phone number, etc., or a combination of the same. These verifications generally attempt to confirm that the customer has physical possession of the credit or debit card or account, and not necessarily that the customer is the true owner of the card or account and/or is authorized to use the same. Furthermore, other existing biometric solutions are not aggressively targeted towards protecting the end-users and they do not truly perform live biometric authentication. Furthermore, the existing biometric solutions do not protect the customer's personal and account information from use or misappropriation by merchants. As a result of the absence of reliable verification and authentication of internet-based payment systems, the degree of fraudulent activities in this area is rapidly increasing. Furthermore, it is not difficult to fraudulently obtain complete information about a credit/debit card account including the billing address, security code, bank phone number, credit card number, etc. Also, payment card counterfeiters are now using the latest computer devices such as embossers, encoders and decoders to read, modify and implant magnetic stripe information on counterfeit payment cards.

### BRIEF DESCRIPTIONS OF THE DRAWINGS

FIG. 1 illustrates a system used by a customer to pay for transactions over the world-wide-web.

FIG. 2 illustrates the method for a customer to enroll in the web based electronic payment system by creating his or her own biometric identification (BID) card.

FIG. 3A illustrates a system used by a customer to enroll in web based electronic payment system, wherein a bank personnel creates the BID card.

FIG. 3B illustrates the method for a customer to be enrolled by a banking institution.

FIG. 4A and FIG. 4B illustrate the method used by a customer to pay for web transactions.

### DETAILED DESCRIPTION OF THE INVENTION

This invention presents a software and hardware solution for authentication and authorization of web-based electronic payment processing using the customer's biometric profile and account information stored in a user-controlled biometric device or a biometric identification card (BID).

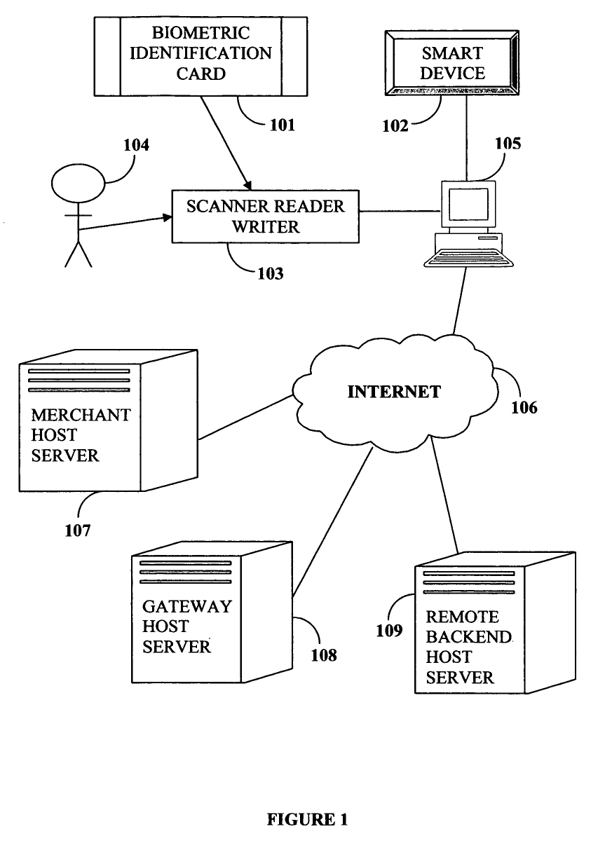

FIG. 1 illustrates a system used by a customer to pay for web transactions. This invention uses a biometric identification (BID) card 101, a hand-held owner-controlled integrated radio frequency identification (RFID) mobile device hereinafter referred to as the smart device 102, a scanner reader writer device 103, a personal computer 105, a merchant host server 107, a remote back-end host server 109, and a gateway host server 108.

The BID card 101 and smart device 102 each holds the owner's personal and account information, for example, the checking, savings, pre-paid, credit or debit accounts, etc., including the biometric profile of the owner, such as the owner's fingerprint templates. The scanner reader writer device 103 is used to scan live biometric templates such as fingerprint templates and to read from and write to the BID card 101. The BID card 101 is placed in the reader writer slot within the scanner reader write device 103. The personal computer 105 runs the web interface application (browser) and a host application is used by the personal computer 105 and remote back-end host server 109 to communicate with the BID card 101 via the scanner reader writer 103 or to communicate with the smart device 102 via a wire-line communication interface. The internet merchant uses the merchant host server 107 to post items for sale on the web that may be purchased by an authenticated customer 104. The merchant host server 107 accepts customer payment requests and submits them for processing to the gateway host server 108, while the remote back-end host server 109 coordinates the authentication and authorization process between the personal computer 105 and the gateway host server 108.

The utilization of this invention requires the implementation of two processes: enrollment of the customer and payment processing.

The enrollment process specifies how a customer 104 obtains his or her BID card 101 or smart device 102, while the payment processing specifies how a customer 104 pays for his or her transaction using a web interface and one of the accounts in the BID card 101 or smart device 102 after a successful biometric authentication. A customer is enrolled via one of three methods:
1. By receiving a BID card or smart device with the customer's personal and account information from a merchant.
2. By the customer creating his or her BID card or smart device.
3. By the customer obtaining the BID card or smart device from an authorized institution.

The first enrollment scenario describes how a customer 104 who previously subscribed for web-based payment processing with a merchant can have their BID card 101 created by the merchant from information provided by the customer in a subscription or application process. Before a merchant can use this method to enroll a customer 104, the customer 104 must have a proven track record of transactions with the personal and account information on record with the merchant, or provide identification that is acceptable to the merchant. This is necessary in order to guarantee that the personal and account information in fact belongs to the customer 104.

The second enrollment scenario describes how a customer 104 can create their BID card 101, or configure smart device 102, using their personal computer 105. The customer 104 registers their credit or debit and bank accounts in a designated web site. A process is initiated to verify that the customer 104 is the true owner of the accounts. After the customer has been authenticated as the true owner of the accounts, the customer 104 logs into the designated web site, completes the verification process, and requests that the enrollment be completed. Subsequently, the personal information with the account information from the registration activity and photo image are stored in the BID card 101 or smart device 102.

The third enrollment scenario describes how a customer 104 can have their BID card 101 created or smart device 102 configured, at an authorized institution such as a bank where the customer 104 has a bank account since the bank will use an existing method of verifying that the customer 104 is the true owner of the credit/debit and/or bank accounts.

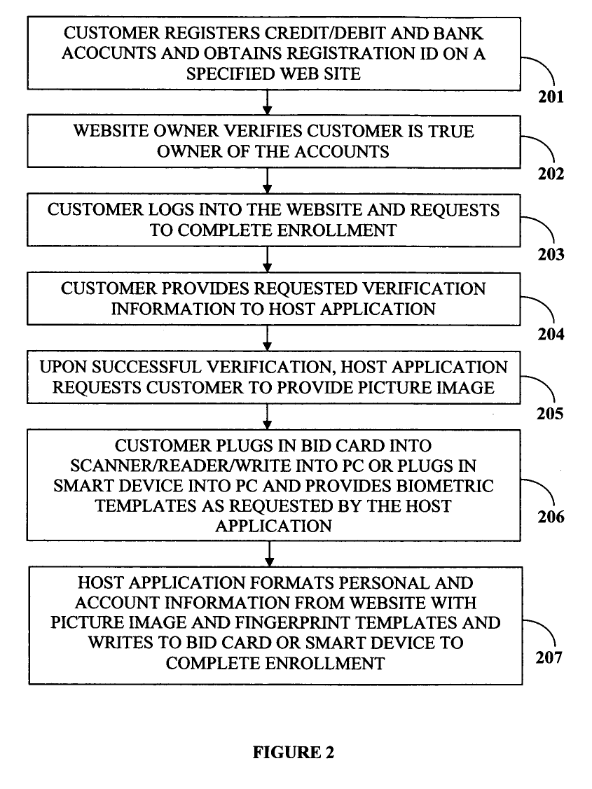

FIG. 2 illustrates the second enrollment scenario, i.e., it illustrates the method used by the customer 104 to enroll in a web based electronic payment system by creating his or her own BID card 101.

The customer 104 goes to the specified web site and fills out the provided forms to register their credit or debit and bank accounts, and a registration identification (ID) is generated 201. The registration information is stored in the merchant's host server 107 which is connected to the internet 106 via wire-line, or wireless communication. Following the registration, the website owner performs internal process checks to verify that the registrant is the true owner of the accounts 202. After a specified period of time, the customer 104 goes back to the same web site or other specified website, logs in with the registration number and requests completion of his or her enrollment 203. The customer 104 subsequently provides requested verification information 204 to prove that he or she is the true owner of the registered accounts. If the verification is successful, the host application requests the customer 104 to provide a photo image 205. The customer 104 then plugs in the BID reader 103 and inserts the BID card 101 in the BID reader, or the customer 104 plugs in their smart device 102 into the personal computer 105, The BID reader 103 and smart device 102 communicates with the personal computer 105 via wire-line or wireless communication channel. Subsequently, upon the request of the host application, the customer 104 provides the biometric template 206. Finally, the host application formats the personal information, account information, photo image, and biometric profiles such as fingerprints and writes to BID card 101 or smart device 102 to complete the enrollment process 207.

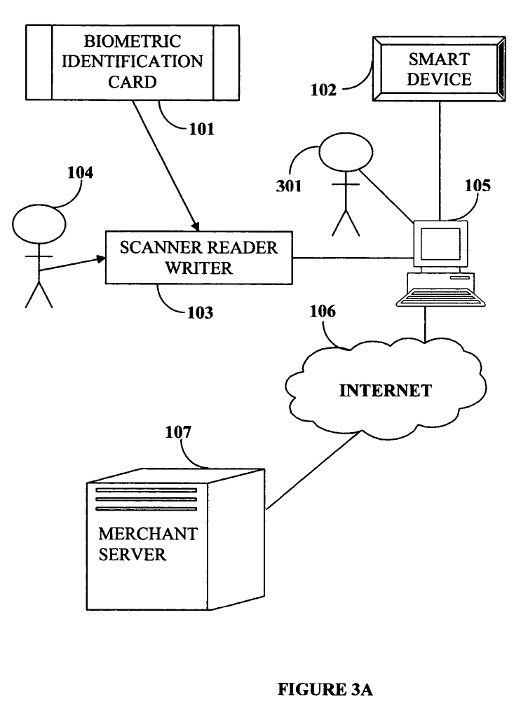

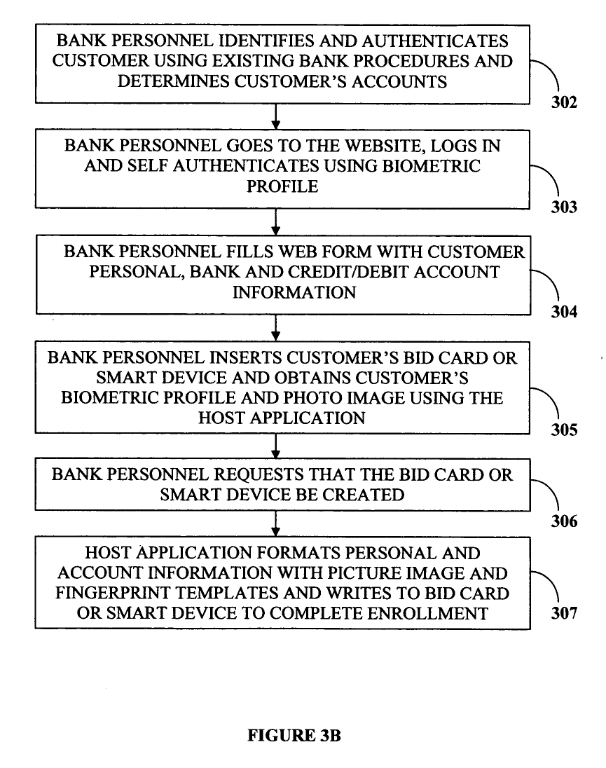

FIG. 3A and FIG. 3B illustrate the third enrollment scenario, i.e., how a customer 104 enrolls and obtains a BID card from a banking institution 110. FIG. 3A illustrates the system that implements the method illustrated in FIG. 3B. FIG. 3A illustrates a system used by a customer 104 to enroll in web based electronic payment system, wherein a bank personnel creates the BID card 101. The customer 104 goes to his or her banking institution. At the bank, the authorized bank employee 301 uses the banking procedures to identify and authenticate the customer's 104 accounts 302. After successfully authenticating the customer 104, the authorized bank employee 301 goes to a designated website, logs in and authenticates himself or herself using his or her fingerprints 303. The authorized bank employee 301 then fills in the web form with customer's 104 personal and account information 304. The bank employee 301 then inserts customer's 104 BID card 101 into scanner reader writer device 103 or plugs in customer's 104 smart device 102 into the personal computer 105 and obtains the customer's 104 biometric profile such as fingerprints and photo image using the host application 305. The smart device 102 communicates with the personal computer 105 via wireless or wire-line communication channel. Next, the bank employee 301 requests the host application to format 306 the BID card 101 or smart device 102. The host application formats the personal and account information with fingerprints and photo image and writes to the BID card 101 or smart device 102 and completes the enrollment process 307.

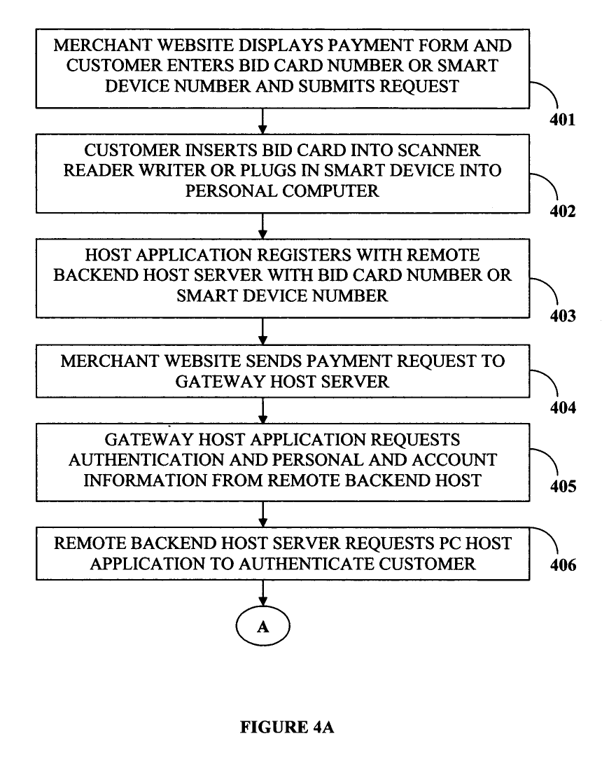

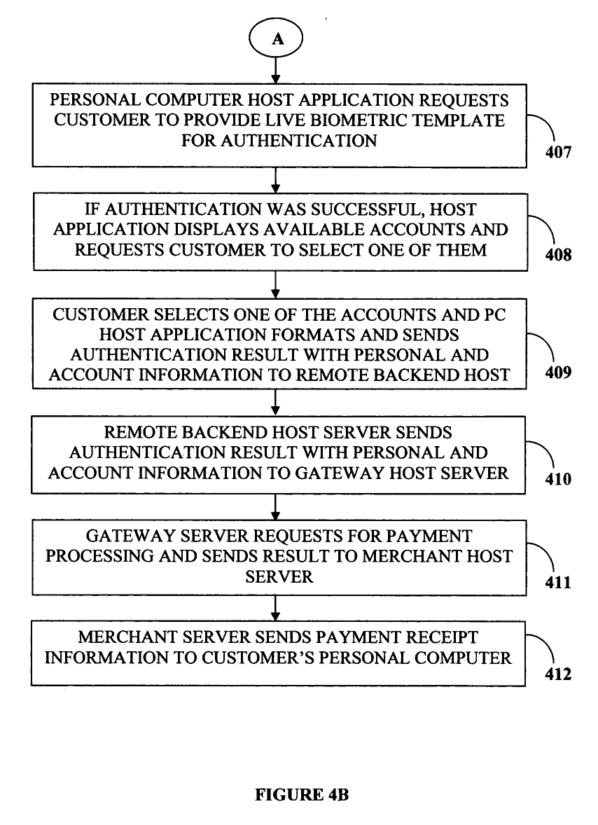

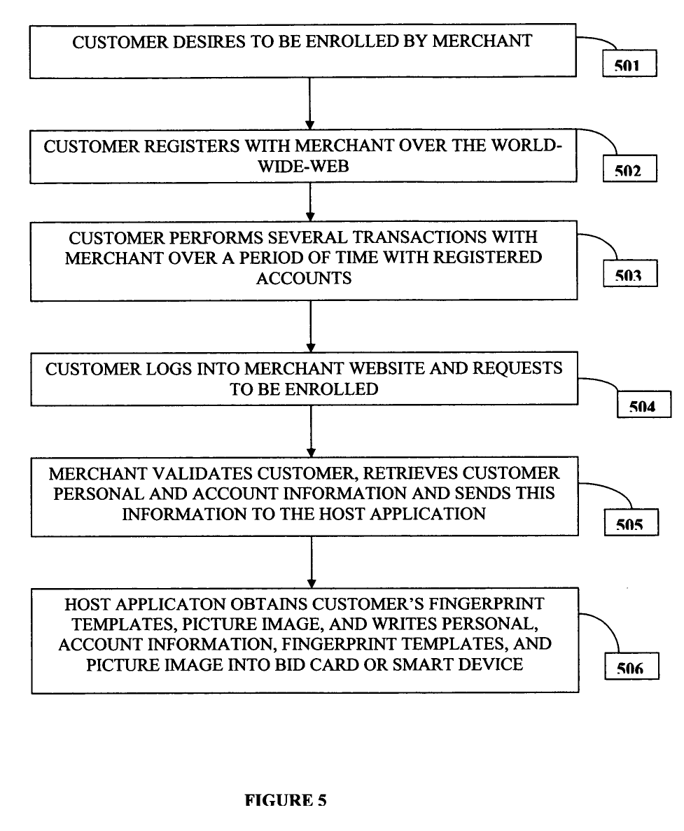

FIG. 4A, FIG. 4B illustrate how a customer 104 pays for web transactions using this invention. FIG. 1 illustrates a system that implements the method shown in FIG. 4A and FIG. 4B, i.e., FIG. 1 illustrates a system used by a customer 104 to pay for web based transactions. Upon request by the customer 104 to pay for the web transactions, the merchant's host server 107 displays the payment form and the customer 104 enters his or her BID card 101 number or smart device 102 number and submits the request 401. Customer 104 also inserts his/her BID card 101 into scanner reader writer device 103 or plugs in smart device 102 into a personal computer 105 that is connected to the internet 106, 402. The host application running on personal computer 105 registers with the remote back-end host server 109 with customer's 104 BID card 101 number or smart device 102 number 403. The merchant host server 107 sends payment request to gateway host server 108 to process the payment 404. The gateway host server 108 requests remote back-end host server 109 to authenticate the customer 104 and return the customer's 104 personal and account information 405. The remote back-end host server 109 then requests the personal computer 105 to authenticate the customer 104 and returns the personal and account information 406 of the customer 104. The personal computer 105 then obtains customer's 104 live biometric template 407 for authentication, and compares them with stored ones in BID card 101 or smart device 102. If the fingerprints match, the personal computer 105 host application displays a form showing the customer's 104 available accounts and asks the customer 104 to select one of the available accounts 408. The customer 104 then selects one of the accounts and the personal computer 105 host application formats and sends the authentication result with the personal and account information to a remote back-end host server 109, 409. The remote back-end host server 109 forwards the authentication result with the customer's 104 personal and account information to the gateway host server 108, 410. If the authentication is successful, the gateway host server 108 then sends the personal and account information for final processing and sends the final result to the merchant host server 107, 411. The merchant host server 107 then generates and sends the payment receipt information 412 to the customer's 104 personal computer 105

FIG. 5 illustrates how a customer 104 is enrolled by a merchant using the merchant host server 107. FIG. 1 illustrates the system that implements the method shown in FIG. 5. Upon request by customer 104, merchant presents a form 501 to the customer 104 which the customer 104 completes to register with the merchant over the world-wide-web 502. During registration, the customer 104 provides his/her personal and account information to the merchant. Over a period of time, the customer performs electronic transactions with the merchant over the world-wide-web with the registered accounts 503. When the customer 104 decides to enrol in the system, he/she logs into merchant website 107 and requests for enrollment 504. The merchant validates customer 104, retrieves customer's personal and account information, and sends this information to host application 505. The customer's 104 personal computer 105 host application obtains customer's fingerprint templates, picture image, and writes personal, account information with fingerprint templates and picture image into the BID card or smart device.

The following example describes how a customer 104 enrolls herself or himself in this system. The example illustrates the second enrollment scenario, i.e., it illustrates the method used by the customer 104 to enroll in a web based electronic payment system by creating his or her own BID card 101. The customer, Mr. John Customer, goes to eneniabiometrics.com website and clicks on the link for customer enrollment. A form is displayed and Mr. Customer enters his Wachovia Visa card number information and his Wachovia checking account information. Mr. Customer then submits the request and a registration number is generated for him. Mr. Customer is also informed to wait for at least 2 days before completing the enrollment. Three days later, Mr. Customer goes back to the eneniabiometrics.com website and clicks on the applicable button to complete his enrollment. Subsequently, he is asked to enter the registration number that was given to him during the registration. Mr. Customer enters the registration number and clicks the continue button. The application then asks Mr. Customer to provide the verification information which Mr. Customer must know if he is the owner of the accounts that were supplied during the first phase of the enrollment. Mr. Customer provides the information and clicks the complete button. If the information provided by Mr. Customer is verified, then the application asks Mr. Customer to provide his fingerprint and photo image via the interface that the application provides. Mr. Customer provides the requested information and clicks the finalize button on the form provided. Mr. Customer then inserts his BID card 101 into a scanner reader writer device 103 or plugs his smart device 102 into the personal computer 105. The application then writes Mr. Customer's personal and account information with the fingerprints and photo image to the smart device 102 or BID card 101.

The following example illustrates the third enrollment scenario, i.e., it illustrates how a customer, Mr. John Customer, who has an account with Wachovia Bank is enrolled by an authorized employee of Wachovia Bank, Ms. Employee. Mr. Customer goes to the nearest Wachovia Bank branch. At the bank, he informs one of the employees that he wants to enroll in this system. Mr. Customer is then directed to Ms. Employee. Ms. Employee uses Wachovia identification process to validate Mr. Customer and identify his Wachovia accounts. Ms. Employee goes to the eneniabiometrics.com website, clicks on the appropriate button for authorized enrollment and gets authenticated biometrically with her fingerprints. Upon successful authentication, the website displays a form for Ms. Employee to enter Mr. Customer's personal, credit/debit and bank account information; and also uploads Mr. Customer's photo image. The web application asks Ms. Employee to insert Mr. Customer's BID card 101 or plug in Mr. Customer's smart device 102. Furthermore, Ms. Employee is required to obtain fingerprints of Mr. Customer. Upon submitting the form with the necessary information, the web application formats and writes all the information into Mr. Customer's BID card 101 or smart device 102. Ms. Employee then removes the BID card 101 or smart device 102 and gives it to Mr. Customer.

The following example illustrates how a customer 104 pays for web transactions using the method disclosed in this invention. This example illustrates how a customer, Mr. John Customer, who has just finished buying some items from the website of a company called New Age, can pay for his items. Mr. Customer enters his BID card 101 number and clicks the appropriate button on the webpage to indicate that he has a BID card 101 or smart device 102 for payment. The information is sent to the New Age host server. To process the payment, the New Age host server sends the amount and Mr. Customer's BID card 101 number or smart device 102 number to its gateway host server 108. The gateway host server 108 then contacts the remote backend host server 109 to authenticate the owner of the BID card 101 or smart device 102 and return the customer's personal and account information. The remote back-end host server 109 then contacts the personal computer 105 that Mr. Customer is using to authenticate Mr. Customer and returns his personal and payment account information. Mr. Customer's personal computer 105 host application then requests Mr. Customer to provide his fingerprints. The host application then compares Mr. Customer's live fingerprints with those stored in the BID card 101 or requests the smart device 102 to authenticate Mr. Customer by comparing the live fingerprint with the one stored in it. If the fingerprints match, the host application then retrieves and displays the accounts in the BID card 101 or smart device 102, and asks Mr. Customer to select one of the accounts. After Mr. Customer has selected one of the accounts, the host application then formats and sends the required information to the back-end host server. The remote back-end host server 109 then sends the information to the gateway host server 108. The gateway host server 108 then completes the payment processing, if the authentication was successful. The gateway host server 108 then sends the result to the merchant host server 107. The merchant host server 107 then prepares the receipt accordingly and sends it to Mr. Customer's personal computer 105 for display.

The following example illustrates the first enrollment scenario, that is, how a customer, Mr. John Customer 104, is enrolled by a merchant 107, New Age Electronics, Inc. (NAE). Mr. Customer registers with NAE on their website with his personal and account information. Over a period of time, Mr. Customer buys several electronic equipment from NAE using his registered credit card accounts. The equipment were successfully delivered to Mr. Customer based on the information on record with NAE. When Mr. Customer decides to enrol in this system, he or she logs into NAE's website and requests to be enrolled. NAE's website validates Mr. Customer as usual, and then retrieves his personal and account information on record, and sends them to the host application running on Mr. Customer's personal computer 105. The host application subsequently requests for Mr. Customer's fingerprint templates and picture image. It then formats and stores the personal, account information with the fingerprint templates and picture image into the BID card 101 or smart device 102.

What is claimed is:

1. A system for payment processing of world wide web based transactions between a customer and a merchant, comprising:
a scanner reader writer for scanning a customer's biometric profile, and for reading from and writing into a biometric identification card;
a biometric identification card for storing a customer's personal and account information including the customer's biometric profile;
a personal computer that runs a web browser that a customer uses to buy items from internet merchants, said personal computer in communication with a remote backend host server or a merchant host server through the internet;
a merchant host server which an internet merchant uses to sell items on the web and which the customer uses to purchase items over the internet and which the customer further submits his or her request to, for payment processing;
a gateway host server which receives the customer's payment information from the merchant host server and which controls the last stages of the payment processing, said gateway host server in communication with the merchant host server through the internet; and
a remote backend host server which coordinates the payment authentication and authorization between the gateway host server and the customer's personal computer.

2. A system for payment processing of world-wide-web based transactions between a customer and a merchant, comprising:
a smart device for storing a customer's personal and account information including the customer's biometric profile and that is plugged into an appropriate interface on a personal computer;
a personal computer that runs a web browser that a customer uses to buy items from internet merchants, said personal computer in communication with a remote back-end host server or a merchant host server through the internet;
a merchant host server which an internet merchant uses to sell items on the web and which the customer uses to purchase items over the internet and over which the customer further submits his or her request for payment processing;
a gateway host server which receives the customer's payment information from the merchant host server and which controls the last stages of the payment processing, said gateway host server in communication with the merchant host server through the internet; and
a remote back-end host server which coordinates the payment authentication and authorization between the gateway host server and the customer's personal computer.

3. A method for a customer to enroll in the system whereby the customer's personal, account and biometric information are stored in a biometric identification card or smart device comprising the steps:
registering the customer's personal and account information and obtaining a registration number for the authentication in a designated website;
validating that customer is the owner of the specified accounts, wherein the step of validation is undertaken by the owner of the designated website;
completing the enrollment at the designated website after a specified period of time and validating that the customer is the true owner of the account
inserting the customers biometric identification card into the reader scanner writer or plugging in the customers smart device into the personal computer, thereby providing the customers biometric template to the website; and
formatting the customer's personal, account, photo and biometric information, encrypting them and writing into the biometric identification card or smart device, wherein the steps of formatting and encrypting are performed by a host application in the personal computer.

4. A method of customer enrollment executed by a banking employee for storing the customer's personal, account, fingerprint, and photo image on a biometric identification card or a smart device, comprising the steps of:
establishing the identify and authenticity of the customer using existing bank procedures and determining the customer's bank accounts;
authenticating using biometrics prior to accessing the banking details of the customer, wherein said authenticating step is performed by the bank employee;
inserting the customer's biometric identification card into a reader scanner writer or plugging in the customer's smart device into a personal computer and obtaining the customer biometric information using a host application; and,
creating, formatting and encrypting and writing the customer's personal and account information on the biometric identification card or smart device.

5. A method for a customer to pay for web transactions on a merchants website using one of the accounts stored in the customer's biometric identification card or smart device, comprising the steps of:
entering the biometric identification card number or smart device number in a form provided by the merchant's website;
inserting the biometric identification card into the reader scanner writer or plugging the smart device into a personal computer that is connected to the internet;
registering the customer's biometric identification card number or smart device number using a host application in the personal computer that connects to a remote backend host server;
sending a payment request via the host application to the gateway host server, said payment request containing information on the customer's biometric identification card number or smart device number;
requesting for customer's authentication and personal and account information from a remote back-end host server via the gateway host server and conducting authentication;
requesting the customer to provide live biometric information, wherein the requesting step is performed by the remote backend host server;
comparing said live biometric information with stored biometric templates in biometric identification card or smart device using customer personal computer via a host application;
reading the biometric identification card or smart device information using the customer personal computer via said host application, and if the authentication is successful, displaying available customer accounts for the customer to choose one among the available customer accounts;
selecting one of said customers accounts and formatting the customer personal and account information by the personal computer host application and sending to the backend host server with successful authentication indication if the authentication is successful;
forwarding the customer personal and account information to the gateway host server via the remote backend host server;
requesting for payment processing with customer information using the gateway host server and sending the payment processing results to the merchant's host server; and
completing payment processing and sending receipt information to the customer's personal computer via the merchant's host server.

6. The method of claim 5, wherein the remote backend host server coordinates the activities between the transaction systems and the customer's personal computer.

7. The method of claim 3, wherein the step of validating that the customer is the true owner of the account includes the step of providing the customer's picture image.
